(19) United States
(12) Patent Application Publication
(10) Pub. No.: US 2026/0011117 A1
(43) Pub. Date: Jan. 8, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Hirokazu TAKAHASHI, Tokyo (JP)

(21) Appl. No.: 19/253,322

(22) Filed: Jun. 27, 2025

(30) Foreign Application Priority Data
Jul. 8, 2024 (JP) 2024-109869

(51) Int. Cl. G06V 10/75; G06T 1/60

(52) U.S. Cl. CPC G06V 10/751; G06T 1/60

(57) ABSTRACT

An image processing apparatus comprises: an image acquisition unit configured to acquire a first image and a second image having parallax; a correlation acquisition unit configured to acquire a plurality of correlation information between an image of a fiducial region in the first image and images of a plurality of reference regions corresponding to the fiducial region in the second image; a parallax amount calculation unit configured to calculate a parallax amount between the image of the fiducial region and the image of the reference region based on the plurality of correlation information; and a storage unit configured to hold, in memory for a predetermined period, pixel data configuring the first image and the second image. The correlation acquisition unit is further configured to sequentially acquire the pixel data configuring the first image and the second image acquired by the image acquisition unit, concatenate the pixel data with a plurality of past pixel data each time the pixel data is acquired, and store the concatenated pixel data at each address of the memory.

### BACKGROUND OF THE INVENTION

### Field of the Invention

The present invention relates to an image processing apparatus, an image processing method, and a program.

### Description of the Related Art

Technology for detecting distance to a subject by using a digital camera is known for acquiring information in autonomous driving, industrial robots, head-mounted displays, and the like. For example, there is a method of arranging two digital cameras at a predetermined interval in a horizontal direction, and comparing images acquired by each digital camera (hereinafter, each image is referred to as a “left image” and a “right image”). In the left image and the right image acquired in this manner, positional deviation according to parallax occurs on an image of the subject according to distance to the subject, and the distance to the subject can be calculated by calculating this positional deviation. For calculation of positional deviation, a region-based corresponding point search technology called template matching is used. In template matching, one of the left image and the right image is set as a fiducial image, and the other image is set as a reference image. In addition, a fiducial region centered on a point of interest is set on the fiducial image, and a reference region centered on a reference point corresponding to the point of interest is also set on the reference image. Then, while sequentially moving the reference point, a point at which correlation between the fiducial region of the left image and the reference region of the right image becomes highest is searched. A positional deviation amount, that is, parallax determined to have high correlation can be converted into a distance value by a predetermined equation by using the interval between the two cameras.

Template matching and other various image processing may be implemented as an LSI. In a case in which template matching is implemented as an LSI, it is necessary to devise a method of holding pixel data so that an image position necessary for template matching can be referenced while acquiring an image from a camera. For example, in Japanese Patent Application Laid-Open No. 2009-070055, search is performed by securing the fiducial region of the fiducial image side and data of a necessary search range of the reference image side on a register circuit. In addition, in Japanese Patent Application Laid-Open No. 2008-108044, upon updating a parallax calculation position, data already secured on the register circuit is shifted horizontally and vertically according to the parallax calculation position.

However, an issue exists in that when pixel data that can be searched by template matching is secured on a register circuit, the circuit scale becomes large. As another method, preparing a dedicated memory unit such as an SRAM, securing several lines of pixel data, and reading out pixel data of a necessary search range as needed is conceivable. SRAM is an abbreviation for Static Random Access Memory. However, in this case, depending on the configuration, an issue exists such that the number of accesses for reading out necessary data increases and throughput decreases. Accordingly, there has conventionally been room for improvement in distance measurement processing.

### SUMMARY OF THE INVENTION

An image processing apparatus according to one embodiment of the present invention comprises an image acquisition unit configured to acquire a first image and a second image having parallax; a correlation acquisition unit configured to acquire a plurality of correlation information between an image of a fiducial region in the first image and images of a plurality of reference regions corresponding to the fiducial region in the second image; a parallax amount calculation unit configured to calculate a parallax amount between the image of the fiducial region and the image of the reference region based on the plurality of correlation information; and a storage unit configured to hold, in a memory for a predetermined period, pixel data configuring the first image and the second image, wherein the correlation acquisition unit sequentially acquires pixel data configuring the first image and the second image acquired by the image acquisition unit, concatenates the pixel data with a plurality of past pixel data each time the pixel data is acquired, and stores the concatenated pixel data at each address of the memory.

Further features of the present invention will become apparent from the following description of embodiments with reference to the attached drawings.

### BRIEF DESCRIPTION OF THE DRAWINGS

FIG. 1 is a diagram showing an overall configuration of a distance measuring apparatus according to a first embodiment of the present invention.

FIG. 2A-FIG. 2G are diagrams showing an example of operation of a correlation calculation unit.

FIG. 3 is a diagram showing a reception order of pixel data in the correlation calculation unit.

FIG. 4 is a diagram showing a line buffer necessary for template matching.

FIG. 5 is a diagram showing a reading method of a conventional line buffer.

FIG. 6 is a diagram showing stored pixel data of a line buffer according to the First Embodiment of the present invention.

FIG. 7 is a diagram showing pixel data read from the line buffer.

FIG. 8A-FIG. 8E are diagrams showing a state in which template matching is performed on a partial search region.

FIG. 9 is a diagram showing a write control flow to the line buffer according to the First Embodiment of the present invention.

FIG. 10 is a diagram showing a read control flow from the line buffer according to the First Embodiment of the present invention.

FIG. 11 is a diagram showing an overall configuration of a distance measuring apparatus according to a second embodiment of the present invention.

FIG. 12 is a diagram showing a read control flow from the line buffer according to the Second Embodiment of the present invention.

### DESCRIPTION OF THE EMBODIMENTS

Hereinafter, an explanation will be provided with respect to embodiments for implementing the present invention by using the drawings. It should be noted that the following embodiments do not limit the present invention according to claims of the present invention, and not all combinations of features described in the present embodiment are essential to the solution means of the present invention.

### First Embodiment

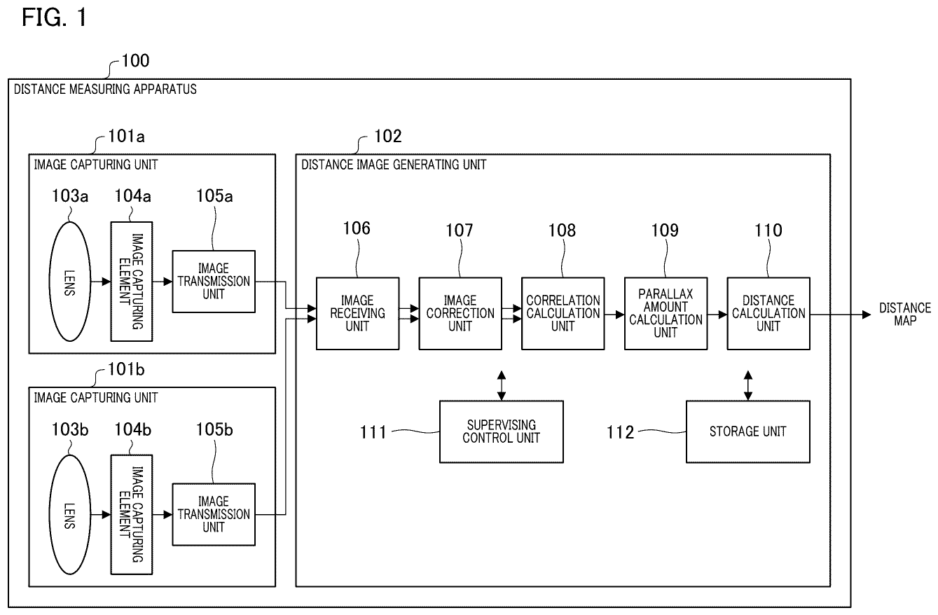

FIG. 1 is a diagram showing an overall configuration of a distance measuring apparatus according to a First Embodiment of the present invention. A distance measuring apparatus 100 has at least two image capturing units including an image capturing unit 101a and an image capturing unit 101b for the purpose of triangulating distance to a subject at each pixel in a captured image. The distance measuring apparatus 100 is an example of an image processing apparatus. Hereinafter, an image acquired by image capturing by the image capturing unit 101a is referred to as a left image serving as a fiducial image, and an image acquired by image capturing by the image capturing unit 101b is referred to as a right image serving as an image having positional deviation. The left image and the right image are examples of a first image and a second image having parallax. The image capturing unit 101a and the image capturing unit 101b are examples of an image acquisition unit configured to acquire a first image and a second image having parallax.

The distance measuring apparatus 100 has a distance image generating unit 102. The distance image generating unit 102 generates a distance map indicating a distance of each pixel based on images from the image capturing unit 101a and the image capturing unit 101b. The distance image generating unit 102 is typically configured by an LSI, a CPU, a program executed by the CPU, a memory device, various IOs, and the like. LSI is an abbreviation for Large Scale Integration. CPU is an abbreviation for Central Processing Unit. IO is an abbreviation for Input/Output.

The image capturing unit 101a has a lens 103a, an image capturing element 104a, and an image transmission unit 105a. The lens 103a is an apparatus that forms an image of a subject on the image capturing element 104a in a subsequent stage. The image capturing element 104a is an image sensor configured by a CMOS (Complementary Metal Oxide Semiconductor) or a CCD (Charge Coupled Device).

A subject image formed on the image capturing element 104a via the lens 103a is converted into an electrical signal by the image capturing element 104a. The image transmission unit 105a transmits the electrical signal acquired by the image capturing element 104a as pixel data to the distance image generating unit 102.

The image capturing unit 101b has a lens 103b, an image capturing element 104b, and an image transmission unit 105b. Since the lens 103b is the same as the lens 103a, the image capturing element 104b is the same as the image capturing element 104a, and the image transmission unit 105b is the same as the image transmission unit 105a, a detailed explanation regarding the lens 103b, the image capturing element 104b, and the image transmission unit 105b is omitted.

The distance image generating unit 102 has an image receiving unit 106. The image receiving unit 106 receives pixel data transmitted from the image capturing unit 101a and the image capturing unit 101b.

The distance image generating unit 102 has an image correction unit 107. The image correction unit 107 performs pre-processing necessary for distance map generation on the pixel data transmitted from the image receiving unit 106. Typical processing serving as the pre-processing includes shading correction processing for correcting uneven luminance due to a decrease in marginal illumination caused by the lens 103a and the lens 103b, filter processing for emphasizing correlation, and the like.

The distance image generating unit 102 has a correlation calculation unit 108. The correlation calculation unit 108 calculates a plurality of correlations between the left image and the right image at each pixel position by template matching and the like within a certain search range. The method of calculating the plurality of correlations will be described below. The correlation calculation unit 108 is an example of a correlation acquisition unit configured to acquire a plurality of correlation information between an image of a fiducial region in the first image and images of a plurality of reference regions corresponding to the fiducial region in the second image.

The distance image generating unit 102 has a parallax amount calculation unit 109. The parallax amount calculation unit 109 calculates parallax amount at each pixel position by selecting a correlation having the highest correlation value from a plurality of correlations calculated by the correlation calculation unit 108. In addition, the parallax amount calculation unit 109 also performs interpolation below search resolution by parabola fitting and the like if necessary. The parallax amount calculation unit 109 is an example of a parallax amount calculation unit configured to calculate a parallax amount between the image of the fiducial region and the image of the reference region based on the plurality of correlation information.

The distance image generating unit 102 has a distance calculation unit 110. The distance calculation unit 110 calculates distance to the subject at each pixel position by using the parallax amount calculated in the parallax amount calculation unit 109 and interval between the two lenses 103a and 103b. The distance image generating unit 102 generates a distance map for the entire image by performing the above-described distance calculation across the entire image.

In addition, the distance image generating unit 102 includes a supervising control unit 111 that governs control of each unit, and a storage unit 112 for holding operation setting values of each unit and for appropriately buffering intermediate data. The storage unit 112 is an example of a storage unit configured to hold, in memory for a predetermined period, pixel data configuring the first image and the second image.

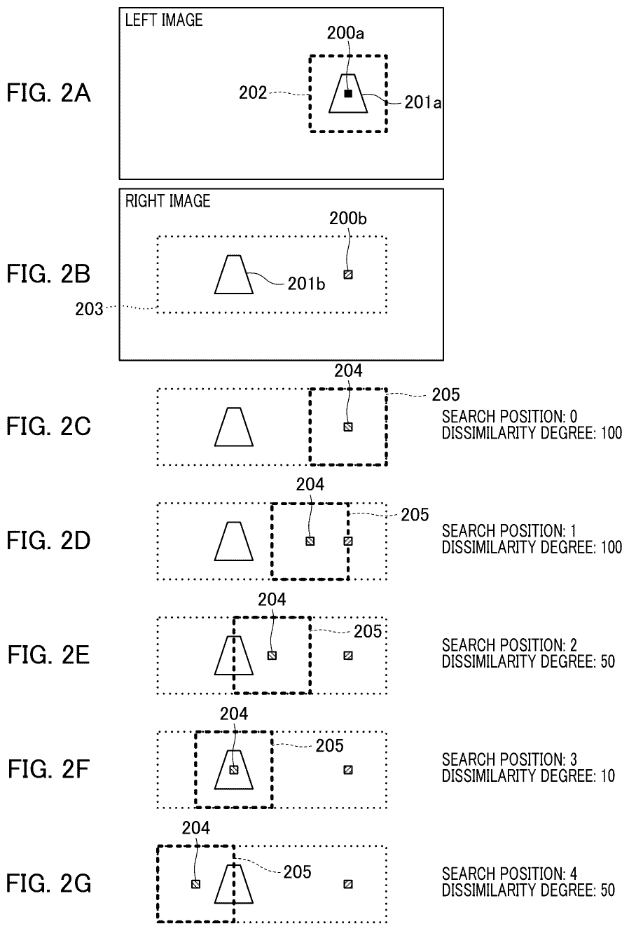

FIG. 2 is a diagram showing an example of operation of the correlation calculation unit 108. FIG. 2A is a diagram showing a left image. Reference numeral 200a denotes a fiducial position at which distance calculation is to be performed in the left image. FIG. 2B is a diagram showing a right image. Reference numeral 200b denotes a corresponding fiducial position indicating the same coordinates as the fiducial position 200a of the left image on the right image. Reference numeral 201a denotes a subject that is captured in the left image. Reference numeral 201b denotes a subject that is captured on the right image corresponding to the same object as the subject 201a of the left image. The subject 201a and the subject 201b exist at different coordinate positions in the left image and the right image due to an arrangement interval between the two lenses 103a and 103b and distance to the subject.

In this context, the two lenses 103a and 103b are assumed to be disposed at an interval in a horizontal direction, and the subject 201a and the subject 201b are captured in a state having parallax in the horizontal direction. For example, the distance image generating unit 102 performs template matching for the purpose of calculating this parallax amount.

Reference numeral 202 denotes a fiducial region for performing template matching. The fiducial region 202 is set at a predetermined size around the fiducial position 200a. Reference numeral 203 denotes a search region for searching for a location similar to the fiducial region 202 in the right image. Since the lens 103a and the lens 103b are disposed at an interval in the horizontal direction, the deviation amount is searched for in the horizontal direction, and the search region 203 becomes a region that is long in the horizontal direction.

FIG. 2C is a diagram showing a reference position in the search region 203, and shows a case in which the search position is 0. FIG. 2D is a diagram showing a reference position in the search region 203, and shows a case in which the search position is 1. FIG. 2E is a diagram showing a reference position in the search region 203, and shows a case in which the search position is 2. FIG. 2F is a diagram showing a reference position in the search region 203, and shows a case in which the search position is 3. FIG. 2G is a diagram showing a reference position in the search region 203, and shows a case in which the search position is 4.

Hereinafter, an explanation is provided with reference to FIG. 2C, FIG. 2D, FIG. 2E, FIG. 2F, and FIG. 2G. Reference numeral 204 denotes a reference position on the right image side for performing template matching. Reference numeral 205 denotes a reference region composed of peripheral pixels around the reference position 204. In the example of FIG. 2, as shown in FIG. 2C, FIG. 2D, FIG. 2E, FIG. 2F, and FIG. 2G, search is performed in five reference regions 205 corresponding to search positions 0, 1, 2, 3, and 4 in the search region 203.

In this context, correlation is calculated at each position of the five reference regions 205, and, for example, as a known technique, SSD and the like are used in which a sum of squares of differences between pixel values of the fiducial region 202 and the reference region 205 serves as a dissimilarity degree. SSD is an abbreviation for Sum of Squared Difference. In a method using SSD, a calculated value represents a dissimilarity degree, and a portion at which the dissimilarity degree becomes smallest is the location having the highest correlation. In the example of FIG. 2, the dissimilarity degree in the reference region 205 corresponding to search position 3 is 10, and because search position 3 is determined to be most similar by the subsequent parallax amount calculation unit 109, 3 is calculated as the parallax amount when search position 3 is selected as having the highest correlation. Then, by using information indicating that the parallax amount is 3, the distance calculation unit 110 calculates the distance to the subject.

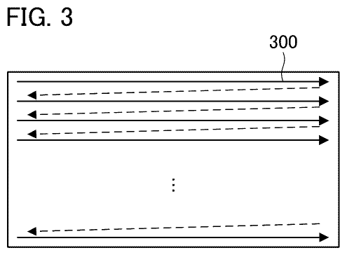

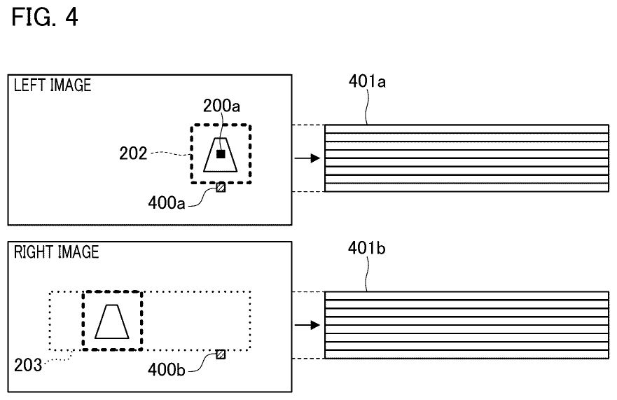

FIG. 3 is a diagram showing a reception order of pixel data received by the correlation calculation unit 108. Reference numeral 300 denotes a reception order, and typically, reception is performed line by line starting from the upper left of the image. Pixel data received by the correlation calculation unit 108 moves from left to right within the image, and upon reaching the right end, moves to the left end of the line immediately below. FIG. 4 is a diagram showing a line buffer necessary for template matching. In template matching, pixel data in the vicinity of the fiducial position 200a at which distance calculation is to be performed is also necessary. Accordingly, actual distance calculation for a certain fiducial position 200a can be performed when the reception order 300 has progressed further, for example, when a pixel 400a and a pixel 400b are received. In addition, since peripheral pixel data is required to be referenced when performing template matching, a line buffer is provided according to a vertical width of the fiducial region 202 and the search region 203.

Reference numeral 401a shown in FIG. 4 denotes a line buffer for the left image, and reference numeral 401b shown in FIG. 4 denotes a line buffer for the right image. When corresponding to the configuration of FIG. 1, the line buffer is configured as a part of the storage unit 112. The line buffer is configured by an SRAM or the like, and an address of the line buffer is associated with a horizontal position of a pixel. In addition, with respect to a vertical position of a pixel, the line buffer is configured by a plurality of SRAMs to enable parallel access. For example, if a vertical width of the fiducial region 202 and the search region 203 is 7, seven SRAMs are prepared for reading in parallel, and one SRAM is prepared for writing by accessing independently from reading, for a total of eight SRAMs. When the reception order 300 advances in the vertical direction, the plurality of prepared line buffers shift the seven readings and one writing that each line buffer was responsible for by one line at a time, and the plurality of prepared line buffers are used while cycling the line buffer numbers of the line buffers being assigned.

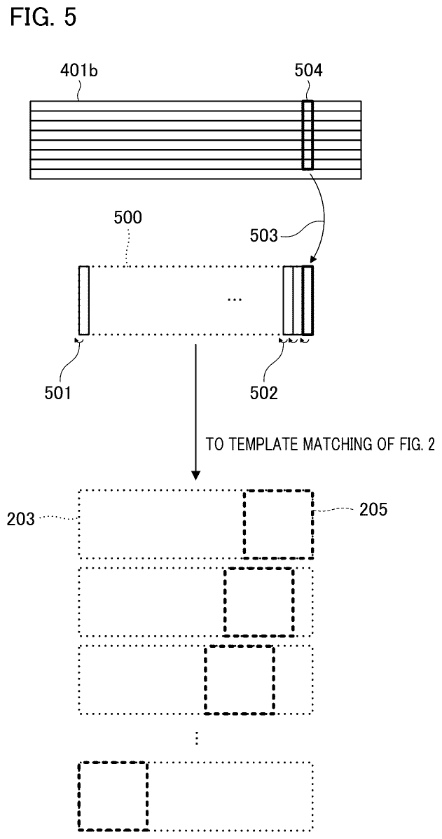

FIG. 5 is a diagram showing a reading method of a line buffer during execution of conventional template matching. Although the line buffer 401a and the line buffer 401b described above read pixel data of one address in one cycle, pixel data necessary for template matching at the fiducial position 200a is in a wide range. Accordingly, while reading data of each address from the line buffer every cycle, the data is shifted to and stored in a register unit 500 included in a calculation unit (not shown).

The register unit 500 indicates pixel data that should be secured in the calculation unit, and in the case of the left image, the register unit 500 corresponds to the fiducial region 202, and in the case of the right image, the register unit 500 corresponds to the search region 203. In FIG. 5, for the purpose of explaining the search region 203 having a larger size among the fiducial region 202 and the search region 203, the line buffer 401b that is the line buffer of the search region 203 is shown.

Hereinafter, with reference to FIG. 5, an explanation is provided with respect to operation when the reception order 300 shown in FIG. 3 advances by one. Reference numeral 501 denotes a data discarding operation, and one vertical column of pixel data that becomes unnecessary is discarded. Reference numeral 502 denotes a data shifting operation, and the data position in the register unit 500 is shifted by one pixel at a time. Reference numeral 503 denotes a line buffer reading operation, and one pixel data is newly stored in the register unit 500 by being read out from one address of the line buffer 401b. The line buffer reading operation 503 reads out one vertical column in parallel from each of the line buffers prepared in parallel for the line buffer 401b. Reference numeral 504 denotes a line buffer read-out position. It should be noted that one of the line buffers 401b is used for writing and does not perform read-out access. By using the pixel data of the register unit 500 secured in this manner, the calculation unit performs template matching at each search position shown in FIG. 2.

However, in the conventional method shown in FIG. 5, the register unit 500 must prepare logical circuits for a portion corresponding to the search region 203, and the circuit scale becomes large. Accordingly, in the present embodiment, necessary pixel data is stored together when storing pixel data in the line buffer, and a plurality of pixel data is made readable in one read.

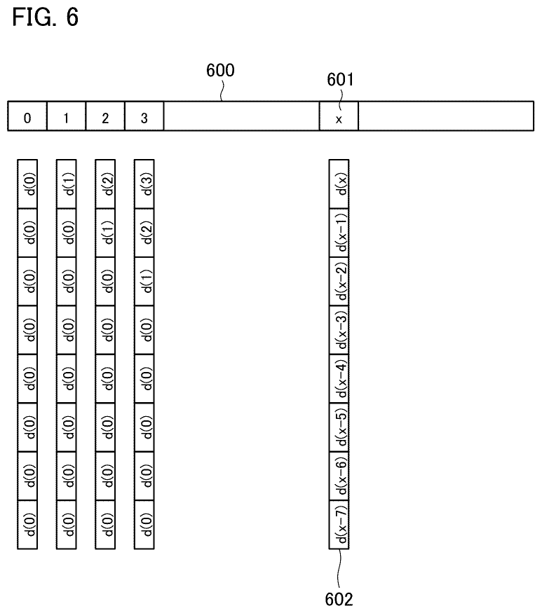

FIG. 6 is a diagram showing pixel data stored in a line buffer according to the present embodiment. Reference numeral 600 denotes a line buffer, and shows one of the line buffer 401a and the line buffer 401b described above. Reference numeral 601 denotes an address, and reference numeral 602 denotes concatenated pixel data stored at the address 601. d(x) indicates that the pixel data is at a position of a horizontal coordinate x. In the present embodiment, a data width storable at each address is expanded, and a plurality of pixel data is stored by concatenating the plurality of pixel data at each address. That is, at a position of address x, for example, eight pixels data from a horizontal coordinate (x-7) to a horizontal coordinate x are included. It should be noted that here, “concatenation” means arranging next data adjacent to previous data without a gap.

When writing pixel data to the line buffer 600, received data is written in concatenation with previous pixel data in the order of the reception order 300. In addition, for concatenation of the next time and thereafter, seven previous pixel data are held in a shift register. A portion at which the horizontal coordinate becomes negative may be filled using a fixed value such as 0, or may be replaced by a value of the horizontal coordinate 0. In FIG. 6, a portion at which the horizontal coordinate becomes negative is replaced by d(0) that is data at the horizontal coordinate 0. Although this storage method requires eight times the capacity of an SRAM configuring the line buffer compared to the conventional method, in a case in which the SRAM is implemented in a predetermined unit size, such as an FPGA and the like, the implementation cost does not necessarily become eight times.

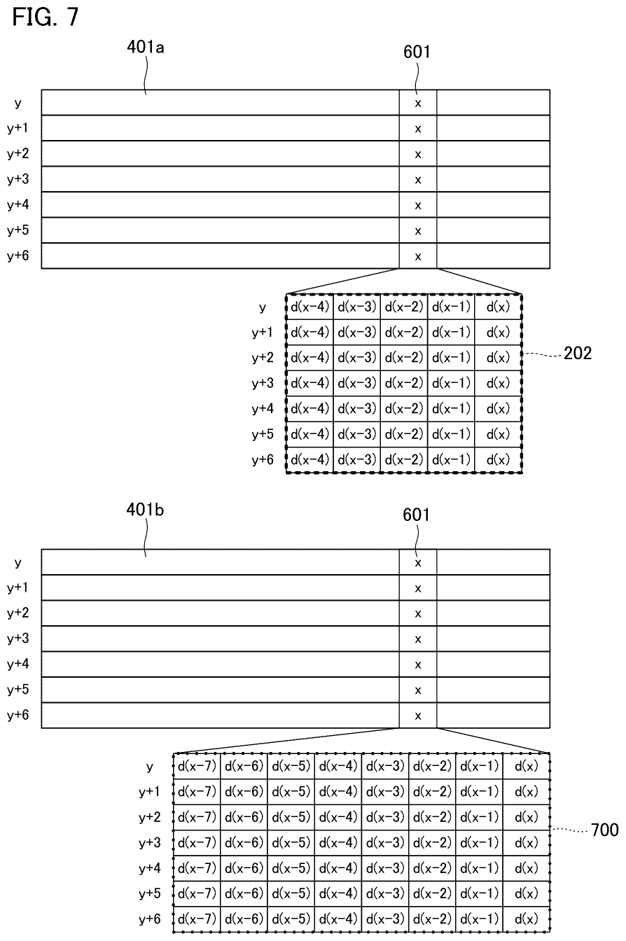

FIG. 7 is a diagram showing examples of pixel data read from a line buffer during template matching. As described above, reference numeral 401a denotes a line buffer for the left image, and reference numeral 401b denotes a line buffer for the right image.

In the line buffer 401a for the left image, concatenated pixel data of five horizontal pixels can be extracted when data of a horizontal address is read. In addition, pixel data of the fiducial region 202 can be prepared in one cycle by reading in parallel from each of the line buffers prepared in parallel vertically.

In the line buffer 401b for the right image, for example, concatenated pixel data of eight horizontal pixels can be extracted in one cycle when data of a horizontal address is read. Here, reference numeral 700 is defined as a partial search region. The partial search region 700 is a pixel data set that can be prepared in one cycle, and is a part of the search region 203. In a case in which template matching does not necessarily need to be performed in one cycle as throughput of input/output of the correlation calculation unit 108, dividing the search region 203 as the partial search region 700 is assumed. It should be noted that the partial search region 700 may be dynamically changed according to the number of search ranges for performing template matching, unit size constraints of the SRAM region described above, operational load per one processing operation, degree of parallelism, and the like.

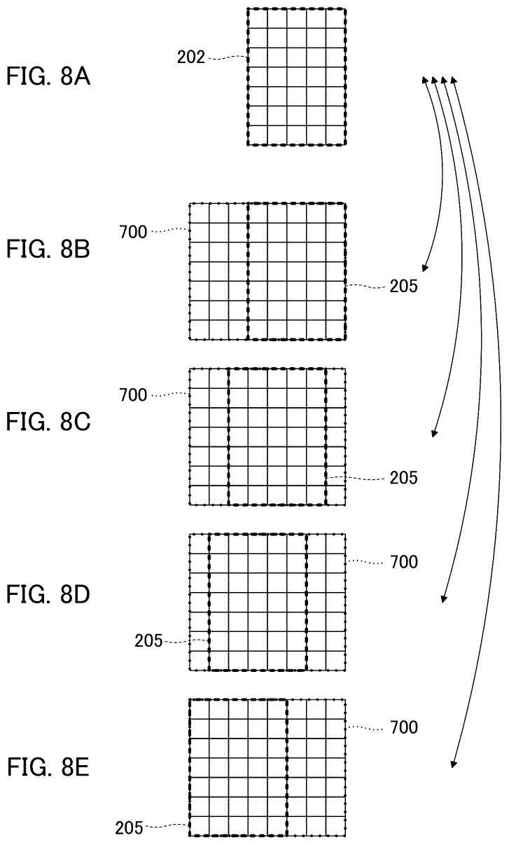

FIG. 8 is a diagram showing a state in which template matching is performed on the partial search region 700. FIG. 8A is a diagram showing the fiducial region 202 for performing template matching. FIG. 8B is a diagram showing the reference position 205 in the partial search region 700, and shows a case in which the search position is 0. FIG. 8C is a diagram showing the reference position 205 in the partial search region 700, and shows a case in which the search position is 1. FIG. 8D is a diagram showing the reference position 205 in the partial search region 700, and shows a case in which the search position is 2. FIG. 8E is a diagram showing the reference position 205 in the partial search region 700, and shows a case in which the search position is 3. In this context, the horizontal size of the fiducial region 202 and the reference region 205 is 5, and because the partial search region 700 includes pixel data of eight horizontal pixels, correlation is calculated by SSD and the like at each position of four reference regions 205 shown in FIG. 8B to FIG. 8E.

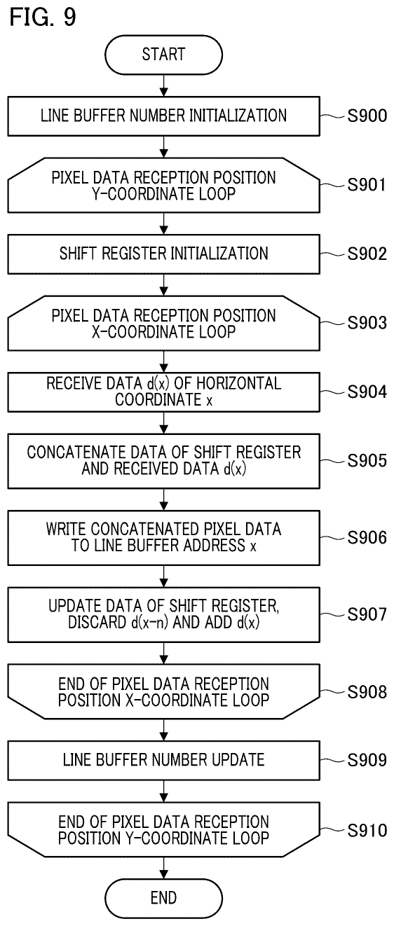

FIG. 9 is a diagram showing a write control to the line buffer among control flows instructed from the supervising control unit 111 according to the First Embodiment. Processing of FIG. 9 corresponds to a part of processing in the correlation calculation unit 108 and processing related to writing data to the storage unit 112. In addition, the present flow is applied to each of operations for the left image and operations for the right image.

In step S900, the correlation calculation unit 108 performs initialization of the line buffer number. In a case in which eight line buffers are prepared for vertical use as described above, the correlation calculation unit 108 assigns an index of numbers 0 to 7 to each of the eight line buffers, and starts operations from the line buffer of line buffer number 0.

Processing from step S901 to step S910 is a loop with respect to the y-coordinate, and performs processing at each pixel position in accordance with the reception order 300, and repeats processing until completion for all y-coordinates.

In step S902, the correlation calculation unit 108 initializes a shift register region for holding data for creating concatenated pixel data. It should be noted that, in exception processing (not shown), the shift register region may be initialized by using the first pixel data after receiving the first pixel data.

Processing from step S903 to step S908 is a loop with respect to the x-coordinate, and performs processing at each pixel position in accordance with the reception order 300, and repeats processing until completion for all x-coordinates.

In step S904, the correlation calculation unit 108 receives data d(x) of the current horizontal coordinate x. In step S905, the correlation calculation unit 108 concatenates data stored in the shift register and data received in step S904. In step S906, the correlation calculation unit 108 writes the data concatenated in step S905 to address x of the current line buffer number. In step S907, the correlation calculation unit 108 adds d(x) by discarding old data d(x-n) from the shift register. n is 4 in a case in which 5 pixels are concatenated for the left image, and is 7 in a case in which 8 pixels are concatenated for the right image. Step S908 indicates completion of the loop corresponding to step S903. That is, the correlation calculation unit 108 sequentially acquires pixel data configuring the first image and the second image acquired by the image acquisition unit in the reception order 300, concatenates the pixel data with a plurality of past pixel data each time the pixel data is acquired, and stores the concatenated pixel data at each address of the memory.

In step S909, the correlation calculation unit 108, upon receiving completion of one horizontal line in step S908, updates the line buffer number to be written from the next time. Step S910 indicates completion of the loop corresponding to step S901. Processing for one frame is completed as described above.

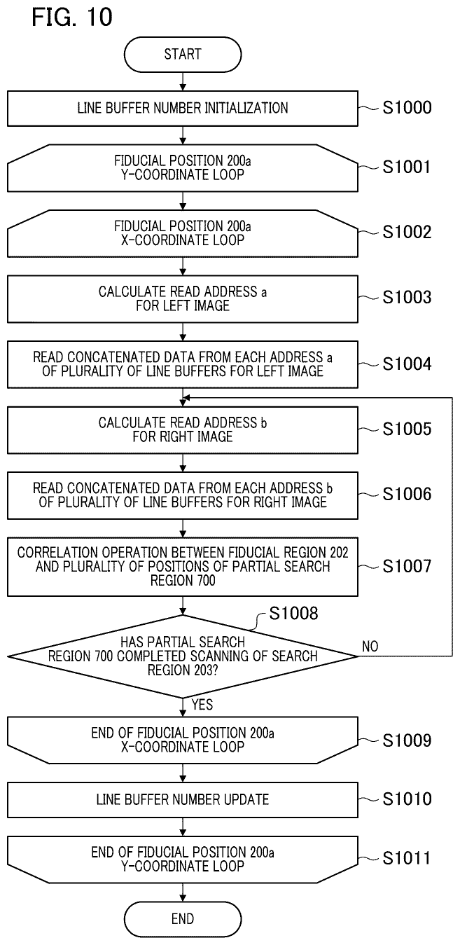

FIG. 10 is a diagram showing read control to the line buffer among control flows FIG. 10 is a diagram showing, according to the First Embodiment, read control to the line buffer among control flows instructed from the supervising control unit 111. Processing of FIG. 10 corresponds to a part of processing in the correlation calculation unit 108 and processing related to reading data from the storage unit 112.

In step S1000, the correlation calculation unit 108 performs initialization of the line buffer number. In a case in which eight line buffers are prepared for vertical use as described above, the correlation calculation unit 108 assigns an index of numbers 0 to 7 to each of the eight line buffers, and starts operations from the line buffers of line buffer numbers 0 to 6. Since a plurality of line buffers for reading are used in parallel in the vertical direction, seven line buffers are assigned.

Processing from step S1001 to step S1011 is a loop with respect to the y-coordinate, and in this context, processing is performed sequentially focusing on the fiducial position 200a. This is separate from the position of the pixel data received in the reception order 300, and is determined, for example, as processing a position four lines before the position at which the pixel data was received as shown in FIG. 4, and the like. Processing from step S1002 to step S1009 is a loop with respect to the x-coordinate, and is for performing processing at each position similar to step S1001.

In step S1003, the correlation calculation unit 108 calculates a read address a for the left image. Since there is a predetermined deviation between the horizontal coordinate of the fiducial position 200a and the address to be read by the line buffer, in the processing of step S1003, the correlation calculation unit 108 corrects the deviation. For example, in a case in which the horizontal width of the fiducial region 202 is 5, the correlation calculation unit 108 needs to read an address two positions to the right of the fiducial position 200a.

In step S1004, the correlation calculation unit 108 reads concatenated data for the left image from the address a calculated in step S1003. At this time, the correlation calculation unit 108 acquires the pixel data necessary for the fiducial region 202 collectively by performing reading in parallel for all line buffers of the plurality of assigned line buffers.

In step S1005, the correlation calculation unit 108 calculates a read address b for the right image. The processing of step S1005 includes correction of deviation from the fiducial position 200a similar to the case of calculating the read address a, in addition to calculation for changing the position of the partial search region 700 described later.

In step S1006, the correlation calculation unit 108 reads concatenated data for the right image from the address b calculated in step S1005. The processing of step S1006, similar to the processing of step S1004, acquires the pixel data necessary for the partial search region 700 collectively by performing reading in parallel for all line buffers of the plurality of assigned line buffers. That is, in step S1004 and step S1006, the correlation calculation unit 108 reads out the concatenated pixel data included in one address of the memory.

In step S1007, the correlation calculation unit 108 performs a correlation operation such as SSD and the like by using the fiducial region 202 and the partial search region 700. As shown in FIG. 8, the correlation calculation unit 108 performs a correlation operation at a plurality of locations that are executable within the partial search region 700. That is, in step S1007, the correlation calculation unit 108 calculates one or a plurality of correlations by using concatenated pixel data.

In step S1008, the correlation calculation unit 108 determines whether the partial search region 700 has completed scanning of the search region 203. In a case in which the correlation calculation unit 108 determines that scanning has not been completed, the correlation calculation unit 108 returns to step S1005, and enables correlation operation to be performed on a new partial search region 700 by changing the read address b. In a case in which the correlation calculation unit 108 determines that scanning has been completed, the correlation calculation unit 108 proceeds to step S1009. Step S1009 indicates completion of the loop corresponding to step S1002. That is, the correlation calculation unit 108 has an adjustment unit configured to adjust an address to be read from the memory, performs a plurality of read operations by repetition according to the determination of step S1008, and thereby calculates a plurality of correlations.

In step S1010, the correlation calculation unit 108, because of one horizontal line in step S1009, updates the line buffer number to be read from the next time. In a case in which the correlation calculation unit 108 was previously using line buffer numbers 0 to 6, for example, the correlation calculation unit 108 uses line buffer numbers 1 to 7 next, and the correlation calculation unit 108 further uses line buffer numbers 2 to 7 and 0 in a cyclic manner in the subsequent operation. Step S1011 indicates completion of the loop corresponding to step S1001. Thereby, processing for one frame is completed.

As described above, according to the present embodiment, in the distance measuring apparatus 100 that calculates distance by performing template matching, necessary parallax search and distance measurement can be performed while reducing register resources of the calculation unit by utilizing a dedicated storage unit. In this context, capacity to be allocated to the storage unit need only be determined according to required throughput and parallax search range.

### Second Embodiment

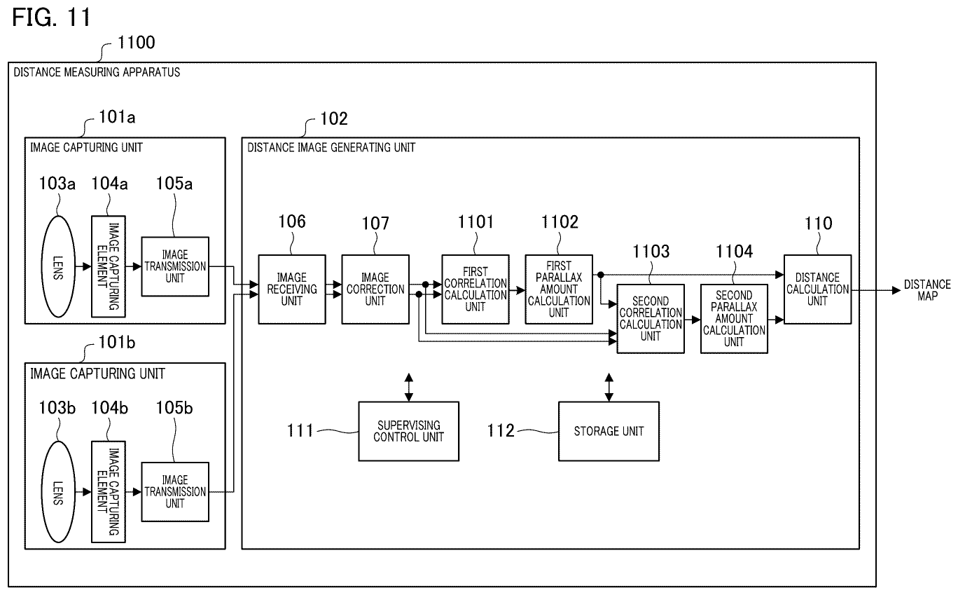

FIG. 11 is a diagram showing an overall configuration of a distance measuring apparatus 1100 according to the Second Embodiment of the present invention. With respect to a configuration that is the same as the First Embodiment, the same reference numerals are assigned, and detailed explanation thereof is omitted. The distance measuring apparatus 1100 according to the Second Embodiment has a first correlation calculation unit 1101 and a first parallax amount calculation unit 1102, and a second correlation calculation unit 1103 and a second parallax amount calculation unit 1104, instead of the correlation calculation unit 108 and the parallax amount calculation unit 109 of the distance measuring apparatus 100 according to the First Embodiment. The distance measuring apparatus 1100 according to the Second Embodiment performs known hierarchical processing using the first correlation calculation unit 1101 and the first parallax amount calculation unit 1102, and the second correlation calculation unit 1103 and the second parallax amount calculation unit 1104. The first correlation calculation unit 1101 and the first parallax amount calculation unit 1102 are examples of an external adjustment unit configured to adjust, from the outside, an address to be read from the memory. The first correlation calculation unit 1101 is an example of a first correlation acquisition unit. The first parallax amount calculation unit 1102 is an example of a first parallax amount calculation unit. The second correlation calculation unit 1103 is an example of a second correlation acquisition unit configured to narrow a target range compared to the first correlation acquisition unit according to a calculation result of the first parallax amount calculation unit, and acquire correlation information between the first image and the second image. The second parallax amount calculation unit 1104 is an example of a second parallax amount calculation unit configured to calculate a parallax amount between the image of the fiducial region and the image of the reference region based on correlation information acquired by the second correlation acquisition unit.

The first correlation calculation unit 1101 and the first parallax amount calculation unit 1102 perform template matching after, for example, performing image reduction for the purpose of simplifying processing, and calculate approximate parallax. The second correlation calculation unit 1103 and the second parallax amount calculation unit 1104 receive a calculation result of the first parallax amount calculation unit 1102, and perform detailed template matching and calculation of parallax only in the vicinity of the parallax position.

Template matching performed by the first correlation calculation unit 1101 may be a known method or may be the method explained in the First Embodiment. The Second Embodiment is an example in which a method according to the present invention is applied to template matching performed by the second correlation calculation unit 1103. Details thereof are explained below.

A diagram showing write control to the line buffer for the second correlation calculation unit 1103 among control flows instructed from the supervising control unit 111 according to the Second Embodiment is similar to FIG. 9 shown in the First Embodiment. The number of search ranges to be performed in the detailed template matching by the second correlation calculation unit 1103 corresponds to the number of pixel data to be concatenated.

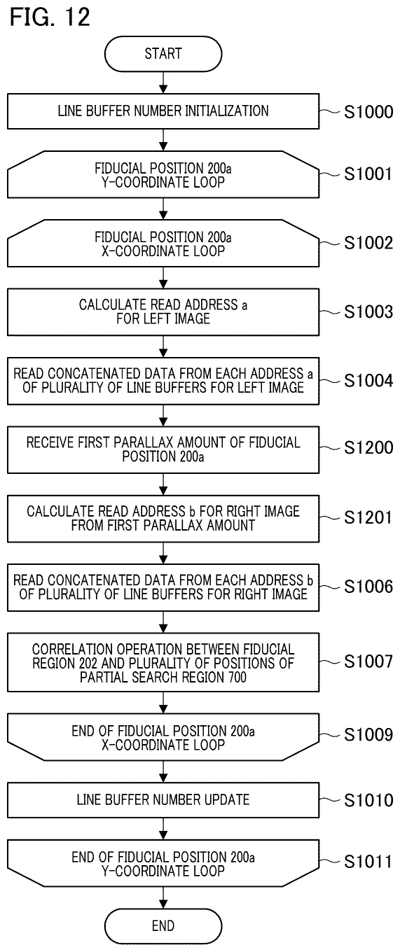

FIG. 12 is a diagram showing read control to the line buffer for the second correlation calculation unit 1103 among control flows instructed from the supervising control unit 111 according to the Second Embodiment. In the processing of FIG. 12, the processing that is the same as the processing of FIG. 10 according to the First Embodiment is assigned the same reference numerals, and detailed explanation thereof is omitted.

In the processing of FIG. 12, since a parallax amount is received from the first parallax amount calculation unit 1102, and correlation operation is performed only on a small region in the vicinity thereof, unlike the processing of FIG. 10, there is no loop with respect to the search region 203.

In step S1200, the second correlation calculation unit 1103 receives a parallax amount that is a calculation result of the first parallax amount calculation unit 1102, that is, a first parallax amount that is a parallax amount corresponding to the fiducial position 200a, from the first parallax amount calculation unit 1102.

In step S1201, the second correlation calculation unit 1103 calculates a read address b for the right image. This operation corrects deviation from the fiducial position 200a similar to a case in which the read address a is calculated, and further determines an address that should be read according to the first parallax amount. A partial search region 700 that is read at an address determined here corresponds to a small region in which template matching is performed in a subsequent stage of hierarchical processing. Processing of step S1007 of FIG. 12 is an example of processing that calculates correlation with respect to an address adjusted by an external adjustment unit configured to adjust, from the outside, an address to be read from the memory.

As described above, in the distance measuring apparatus 1100 that calculates distance by performing template matching according to the present embodiment, parallax amount calculation is hierarchically performed. At this time, high throughput can be realized while reducing register resources of the operation unit by causing capacity allocated to the storage unit to correspond to the search range necessary for the second correlation calculation unit 1103.

### (Other Variations)

The present invention is not limited to the above-described examples, and various embodiments can be adopted within a scope not departing from the spirit thereof. For example, a configuration may exist in which a part is shared by the image capturing unit 101a and the image capturing unit 101b, and an image capturing element having pixels for distance measurement may be utilized. Although SSD is mentioned as a method for calculating correlation by template matching in each embodiment described above, other correlation calculation methods are also applicable when processing requires referencing surroundings of a point of interest. In addition, not being limited to parallax calculation, the present invention is also applicable to, for example, filter processing and the like, when the processing similarly requires referencing surroundings of a point of interest.

It should be noted that a computer program that realizes functions of the examples described above for a part of control in each embodiment may be supplied to an image processing apparatus and the like via a network or various storage media. Subsequently, a computer (or a CPU, MPU, and the like) in the image processing apparatus and the like may execute the program by reading out the program. In a case in which the program is executed, the present invention is configured by the program and a storage medium storing the program.

### OTHER EMBODIMENTS

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the image processing apparatus and the like through a network or various storage media. Then, a computer (or a CPU, an MPU, or the like) of the image processing apparatus and the like may be configured to read and execute the program. In such a case, the program and the storage medium storing the program configure the present invention.

In addition, the present invention includes an implementation using at least one processor or circuit configured to function of the embodiments explained above. It should be noted that distributed processing may be performed by using a plurality of processors.

As described above, although preferred embodiments of the present invention have been explained, the present invention is not limited thereto, and various modifications and changes are possible within the scope of the essence thereof.

This application claims the benefit of priority from Japanese Patent Application No. 2024-109869, filed on Jul. 8, 2024, which is hereby incorporated by reference herein in its entirety.

What is claimed is:

1. An image processing apparatus comprising:
an image acquisition unit configured to acquire a first image and a second image having parallax;
a correlation acquisition unit configured to acquire a plurality of correlation information between an image of a fiducial region in the first image and images of a plurality of reference regions corresponding to the fiducial region in the second image;
a parallax amount calculation unit configured to calculate a parallax amount between the image of the fiducial region and the image of the reference region based on the plurality of correlation information;
a storage unit configured to hold, in a memory for a predetermined period, pixel data configuring the first image and the second image,
wherein the correlation acquisition unit is further configured to sequentially acquire pixel data configuring the first image and the second image acquired by the image acquisition unit, concatenate the pixel data with a plurality of past pixel data each time pixel data is acquired, and store the concatenated pixel data at each address of the memory.

2. The image processing apparatus according to claim 1, wherein the correlation acquisition unit is configured to calculate correlation by template matching.

3. The image processing apparatus according to claim 1, wherein the correlation acquisition unit is configured to read out concatenated pixel data included in one address of the memory and calculate one or a plurality of correlations by using the concatenated pixel data.

4. The image processing apparatus according to claim 1, wherein the correlation acquisition unit has function configured to adjust an address to be read from the memory, performs a plurality of read operations, and thereby calculates a plurality of correlations.

5. The image processing apparatus according to claim 1, wherein
the correlation acquisition unit is a first correlation acquisition unit,
the parallax amount calculation unit is a first parallax amount calculation unit, and
the image processing apparatus further comprises:
a second correlation acquisition unit configured to narrow a target range compared to the first correlation acquisition unit according to a calculation result of the first parallax amount calculation unit, and acquire correlation information between the first image and the second image; and
a second parallax amount calculation unit configured to calculate a parallax amount between the image of the fiducial region and the image of the reference region based on correlation information acquired by the second correlation acquisition unit.

6. A control method of an image processing apparatus, comprising:
acquiring a first image and a second image having parallax;
acquiring a plurality of correlation information between an image of a fiducial region in the first image and images of a plurality of reference regions corresponding to the fiducial region in the second image;
calculating a parallax amount between the image of the fiducial region and the image of the reference region based on the plurality of correlation information;
holding pixel data configuring the first image and the second image in memory for a predetermined period,
wherein acquiring the correlation comprises sequentially acquiring pixel data configuring the first image and the second image acquired by the acquiring of the images, concatenating the pixel data with a plurality of past pixel data each time the pixel data is acquired, and storing the concatenated pixel data at each address of the memory.

7. A non-transitory computer-readable storage medium configured to store a computer program comprising instructions for executing the functions of the following units:
an image acquisition unit configured to acquire a first image and a second image having parallax;
a correlation acquisition unit configured to acquire a plurality of correlation information between an image of a fiducial region in the first image and images of a plurality of reference regions corresponding to the fiducial region in the second image;
a parallax amount calculation unit configured to calculate a parallax amount between the image of the fiducial region and the image of the reference region based on the plurality of correlation information; and
a storage unit configured to hold pixel data configuring the first image and the second image in memory for a predetermined period,
wherein the correlation acquisition unit is further configured to sequentially acquire pixel data configuring the first image and the second image acquired by the image acquisition unit, concatenate pixel data with a plurality of past pixel data each time pixel data is acquired, and store the concatenated pixel data at each address of the memory.
